(19) United States
(12) Patent Application Publication
(10) Pub. No.: US 2018/0307082 A1
(43) Pub. Date: Oct. 25, 2018

(54) DISPLAY DEVICE

(71) Applicants: HKC Corporation Limited, Shenzhen City, Guangdong (CN); Chongqing HKC Optoelectronics Technology Co., Ltd., Chongqing (CN)

(72) Inventor: Chung-Kuang CHIEN, Chongqing (CN)

(21) Appl. No.: 15/578,447

(22) PCT Filed: Jul. 7, 2017
(86) PCT No.: PCT/CN2017/092236

§ 371 Date: Nov. 30, 2017

(30) Foreign Application Priority Data
Mar. 9, 2017 (CN) 201710138828.7

(51) Int. Cl. G02F 1/1333; G02F 1/1335; G02F 1/1339; F21V 8/00; G02F 1/1368

(52) U.S. Cl. CPC G02F 1/133308; G02F 1/133512; G02F 1/133514; G02F 2001/133317; G02F 1/1339; G02B 6/0055; G02F 1/1368; G02F 1/133602

(57) ABSTRACT

This application provides a display device, including: a bezel; a backlight module, disposed on the bezel; a display panel, disposed opposite to the backlight module, including a first substrate and a second substrate, and having an outer surface; a light shielding unit, disposed at a periphery of the outer surface of the display panel; and a middle frame unit, including a spacer molded integrally, where the spacer extends from a direction perpendicular to the periphery of the middle frame unit and is connected to the light shielding unit, where the light shielding unit is made of a liquid adhesive material, and the light shielding unit is located at the periphery of the display panel and adhered to the display panel and the spacer of the middle frame unit.

### BACKGROUND

### Technical Field

This application relates to a designing method for an assembled structure, and in particular, to a display device.

### Related Art

A TFT-LCD is short for a thin film transistor liquid crystal display. The TFT-LCD is a backlight type LCD, and includes an LCD panel and a backlight module. The LCD panel includes: a first substrate: a color filter (CF) substrate, a second substrate: a TFT substrate, and a liquid crystal (LC) sandwiched between the CF substrate and the TFT substrate. Low Temperature poly-silicon (LTPS) is a manufacturing process of a new-generation TFT-LCD. A greatest difference between the LTPS and a conventional amorphous silicon (a-Si) display lies in that the LTPS has a relatively high reaction speed, and has such advantages as high brightness, high resolution, and low power consumption. The TFT-LCD has two technologies: a poly-silicon technology and an a-Si technology. Currently, popular TFT-LCDs are mainly based on a-Si, and related technologies are relatively mature. An LCD cannot emit light, and therefore, a backlight module is required. The backlight module may include a light source such as a light-emitting diode or a fluorescent lamp, a light guide plate, a prism sheet, a diffuser, a protective sheet, and the like. A CF is a key factor for which the TFT-LCD can display a colored image. The CF is coated with color photoresists of three colors: red, green, and blue. After a light source penetrates through the CF, the light source immediately forms red, green, and blue light, and finally, the light is mixed into a colored image in human eyes.

To highlight integrity of a displayed image, a TFT-LCD starts to use a frameless design. However, after a frame is abandoned, a problem of side light leakage at the periphery needs to be resolved, or otherwise, a light leakage phenomenon at the periphery occurs. Moreover, when a panel array side of a frameless product is displayed upwards, surrounding metal reflection leads to a poor visual sense, affecting quality of a panel.

In an existing manufacturing process, when a display panel (open cell) is combined with a middle frame, a double-sided black adhesive tape is used for adhesion and preventing light leakage. However, a solid-state adhesive tape is nonresistant to environmental changes, and easily generates problems such as bubbles and embrittlement after a long time. Moreover, with the development towards a thin product and application of a narrow frame, the black adhesive tape is required to be thinner, and because two sides of the double-sided adhesive tape need to respectively be adhered to two different media: an iron frame and glass, a large adhesive force is required. Because a liquid adhesive has advantages such as good adhesiveness, resistance to environmental changes, and controllability of the width of the liquid adhesive by adjusting an adhesive amount, and has good adhesiveness, light shielding performance, and weather resistance, a black liquid adhesive may be developed to replace the existing black adhesive tape and combine the middle frame and the display panel (open cell).

### SUMMARY

To resolve the foregoing technical problem, an objective of this application is to provide a designing method for an assembled structure, and in particular, this application relates to a display device, so as to not only absorb metal light reflection surrounding a TFT glass substrate, but also alleviate a problem of a poor visual sense due to metal light reflection.

The objective of this application is achieved and the technical problem of this application is resolved by using the following technical solution. A display device provided according to this application comprises: a bezel; a backlight module, disposed on the bezel; a display panel, disposed opposite to the backlight module, comprising a first substrate and a second substrate, and having an outer surface; a light shielding unit, disposed at a periphery of the outer surface of the display panel; and a middle frame unit, comprising a spacer molded integrally, where the spacer extends from a direction perpendicular to the periphery of the middle frame unit and is connected to the light shielding unit, where the light shielding unit is made of a liquid adhesive material, and the light shielding unit is located at the periphery of the display panel and adhered to the display panel and the spacer of the middle frame unit.

The objective of this application may further be achieved and the technical problem of this application may further be implemented by using the following technical measure.

In an embodiment of this application, the liquid adhesive material is a dark-color light absorbing material.

In an embodiment of this application, the dark-color light absorbing material can block or absorb reflected light.

In an embodiment of this application, the liquid adhesive has adhesiveness, and is a material capable of adhering glass and metal and a metal compound.

In an embodiment of this application, the liquid adhesive has high temperature stability, and maintains a stable property under a condition of high temperature.

In an embodiment of this application, the bezel is made of aluminum or a composite material of aluminum.

In an embodiment of this application, the first substrate is disposed above the backlight module, and the first substrate is a CF substrate.

In an embodiment of this application, the second substrate is disposed opposite to the first substrate, and the second substrate is a TFT substrate.

In an embodiment of this application, the display device further comprises an LC layer, disposed between the first substrate and the second substrate.

Another objective of this application is to provide an LCD device, comprising: a bezel; a backlight module, disposed on the bezel; a display panel, disposed opposite to the backlight module, comprising a first substrate and a second substrate, and having an outer surface, where the first substrate comprises a CF, and the second substrate comprises a TFT; a light shielding unit, disposed at a periphery of the outer surface of the display panel; and a middle frame unit, comprising a spacer molded integrally, where the spacer extends from a direction perpendicular to the periphery of the middle frame unit and is connected to the light shielding unit; the light shielding unit is made of a liquid adhesive material, and the light shielding unit is located at the periphery of the display panel and adhered to the display panel and the spacer of the middle frame unit; the liquid adhesive has adhesiveness, and is a material capable of adhering glass and metal and a metal compound; and has high temperature stability, and maintains a stable property under a condition of high temperature; the liquid adhesive material is a dark-color light absorbing material, and the dark-color light absorbing material blocks or absorbs reflected light; the bezel is made of aluminum or a composite material of aluminum; and steps of forming the first substrate and the second substrate comprise photoresist coating, exposure, development, and photomask processes.

According to this application, not only metal light reflection surrounding a TFT glass substrate can be absorbed, but also a problem of a poor visual sense due to metal light reflection can be alleviated. Because a liquid adhesive has advantages such as good adhesiveness, resistance to environmental changes, and controllability of the width of the liquid adhesive by adjusting an adhesive amount, and has good adhesiveness, light shielding performance, and weather resistance, a black liquid adhesive is used to replace a black double-sided adhesive tape used during assembly of a display panel. Because the liquid adhesive has better adhesiveness and resistance to environmental changes, and is not limited by a development towards a thin product and a narrow frame, there is no need to add an additional manufacturing process.

### BRIEF DESCRIPTION OF THE DRAWINGS

FIG. 1 is a schematic structural diagram of a backlight module of an exemplary conventional LCD;

FIG. 1a is a schematic diagram of an exemplary display device;

FIG. 1b is a top view of an exemplary display device;

FIG. 2a is a schematic diagram of a display device according to an embodiment of this application; and

FIG. 2b is a top view of a display device according to an embodiment of this application.

### DETAILED DESCRIPTION

The following embodiments are described with reference to the accompanying drawings, and are used to exemplify particular embodiments for implementation of this application. Terms about directions mentioned in this application, such as “above”, “below”, “front”, “back”, “left”, “right”, “in”, “out”, and “side surface” merely refer to directions of the accompanying drawings. Therefore, the used terms about directions are used to describe and understand this application, and are not intended to limit this application.

The accompanying drawings and the description are considered to be essentially exemplary, rather than limitative. In the figures, units of similar structures are represented by using same numerals. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a substrate is described to be “above” “another component”, the component may be directly above the another component, or there may be an intermediate component.

In addition, in this specification, unless otherwise explicitly described to have an opposite meaning, the word “include” is understood as including the component, but not excluding any other component. In addition, in this specification, “above” means that a component is located above or below a target component, but does not mean that the component needs to be located on the top of a gravity direction.

To further describe the technical means used in this application to achieve the application objective and effects thereof, specific implementations, structures, features, and effects of a display device provided according to this application are described in detail below with reference to the drawings and preferred embodiments.

An LCD applies an electric field to an LC between two glass substrates, to display numbers or images. The LC is formed by a substance intermediate between liquid and solid. The LCD cannot emit light, and therefore, a backlight module is needed to provide light. A picture is formed by controlling transmission of light of an LCD panel. The LC is evenly disposed in the LCD panel.

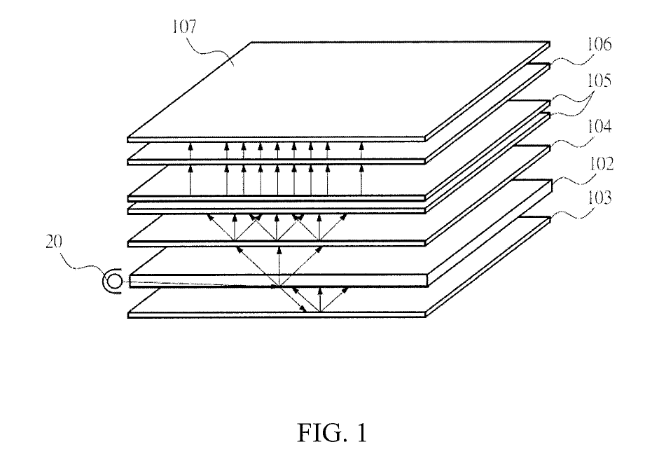

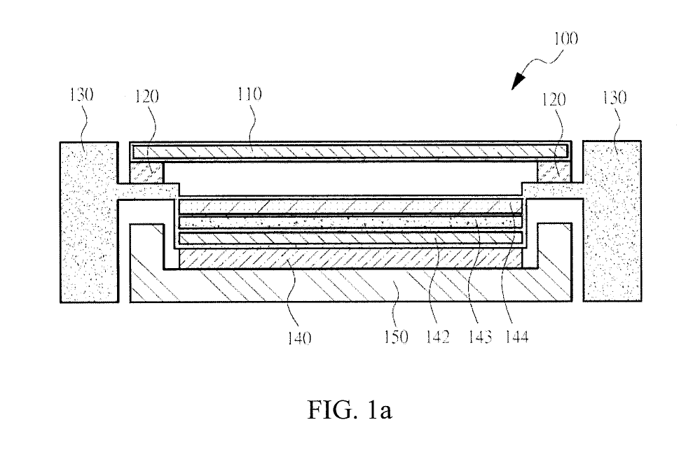

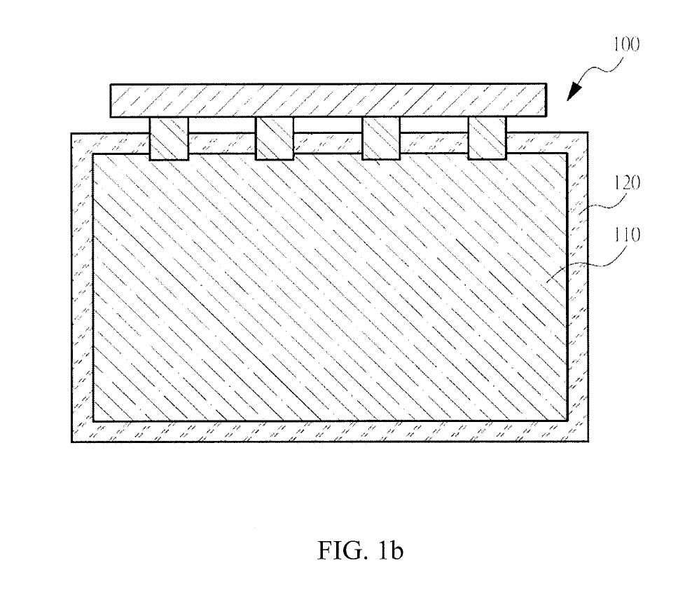

FIG. 1 is a schematic structural diagram of a backlight module of an exemplary conventional LCD. The backlight module (as shown in FIG. 1) of the conventional LCD includes a light source 20, a light guide plate 102, a reflection sheet 103, a diffuser 104, a prism sheet 105, and a protective sheet 106. First, the light source 20 is configured to emit light to the LCD. Currently, a plurality of different light sources that can be applied to the LCD. The light guide plate 102 is disposed below an LCD panel 107, and is adjacent to a side of the light source 20. The light guide plate 102 is configured to convert dot-shaped light generated by the light source 20 into planar light, and project the planar light on the LCD panel 107.

The reflection sheet 103 is disposed below the light guide plate 102. The reflection sheet 103 is configured to reflect the light emitted by the light source 20 to the LCD panel 107 in front of the reflection sheet 103. The diffuser 104 is disposed above the light guide plate 102 and is configured to homogenize the light passing through the light guide plate 102. When the light penetrates through the diffuser 104, the light is diffused in horizontal and vertical directions. In this case, brightness of the light rapidly decreases. In terms of this, the prism sheet 105 is configured to refract and concentrate the light, to increase the brightness. Generally, two prism sheets 105 are arranged in a manner of being perpendicular to each other.

The protective sheet 106 is disposed above the prism sheet 105. When two prism sheets 105 arranged in a manner of being perpendicular to each other are used, the protective sheet 106 can avoid scratches on the prism sheets 105, and prevent a phenomenon of a moiré effect. The backlight module of the conventional LCD includes the foregoing components.

Generally, when the prism sheet 105 is normally assembled, a plurality of unit prisms is arranged on a film of a transparent material in a regular direction. The prism sheet 105 is configured to refract light penetrating through the light guide plate 102 and diffused by the diffuser 104. Generally, if widths of transmitted light and refracted light are relatively small, light in transmission and refraction areas is relatively bright. On the contrary, if widths of transmitted light and refracted light are relatively large, light in transmission and refraction areas is relatively dim.

In recent years, an LCD tends to have a panel of a large size. Therefore, how to maintain density of light emitted by the backlight module above a predetermined level is a problem. Moreover, to highlight integrity of a displayed image, the LCD starts to use a frameless design. However, after the frame is cancelled, a problem of side light leakage at the periphery needs to be resolved, or otherwise, a light leakage phenomenon at the periphery occurs. Moreover, when a panel array side of a frameless product is displayed upwards, surrounding metal reflection leads to a poor visual sense, affecting quality of a panel. Therefore, how to homogenize light seen and resolve the problem of side light leakage at the periphery is an importance reference factor for a panel of a large size.

An LCD device in this application may include a backlight module and an LCD panel. The LCD panel may include a TFT substrate, a CF substrate, and an LC layer formed between the two substrates.

In an embodiment, the LCD panel of this application may be a curved display panel, and the LCD device of this application may also be a curved display device.

FIG. 1a is a schematic diagram of an exemplary display device; and FIG. 1b is a top view of the exemplary display device. Referring to FIG. 1a and FIG. 1b, a display device 100 includes: a bezel 150; a backlight module 140, disposed on the bezel 150; a display panel 110, disposed opposite to the backlight module 140, including a first substrate and a second substrate, and having an outer surface; a light shielding unit 120, disposed at a periphery of the outer surface of the display panel 110; and a middle frame unit 130, connected to the light shielding unit 120.

In an embodiment, when the light shielding unit 120 is disposed at a periphery of the outer surface of the display panel 110, the light shielding unit 120 is located between the display panel 110 and the middle frame unit 130.

In an embodiment, the bezel 150 is made of aluminum or a composite material of aluminum.

In an embodiment, the light shielding unit 120 is a black material.

In an embodiment, the black material is a black double-sided adhesive tape.

In an embodiment, the first substrate 142 is disposed above the backlight module 140, and the first substrate 142 is a CF substrate.

In an embodiment, the second substrate 144 is disposed opposite to the first substrate 142, and the second substrate 144 is a TFT substrate.

In an embodiment, the display device further includes an LC layer 143, disposed between the first substrate 142 and the second substrate 144.

In an embodiment, manners of foil ling the first substrate 142 and the second substrate 144 include photoresist coating, exposure, development, and photomask processes.

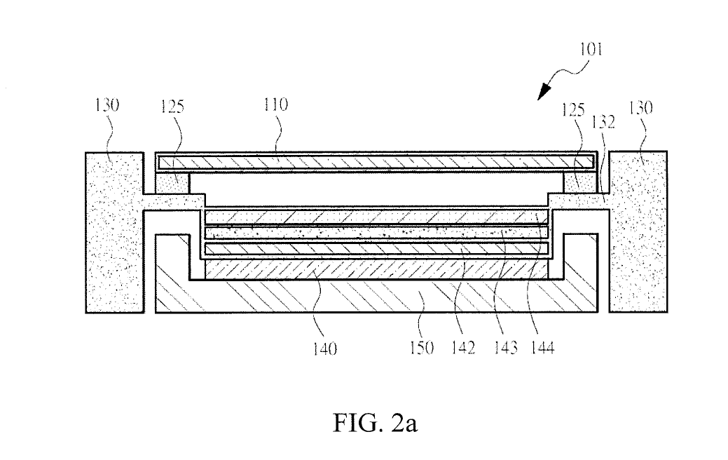

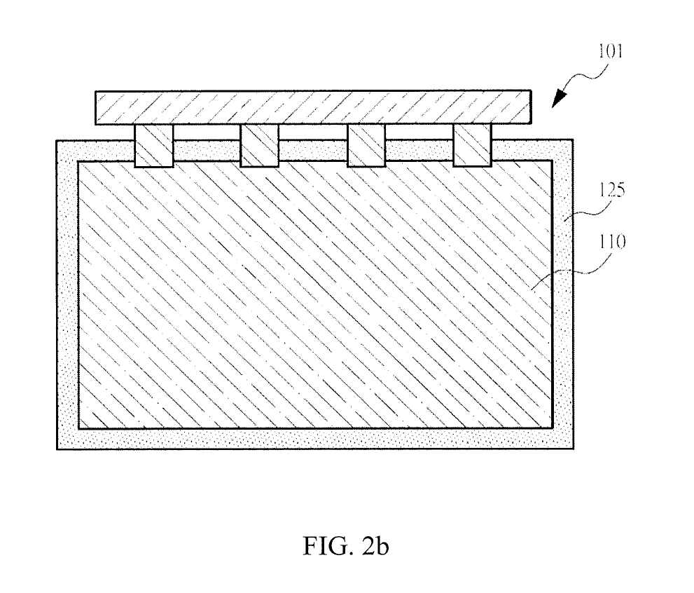

FIG. 2a is a schematic diagram of a display device according to an embodiment of this application; and FIG. 2b is a top view of a display device according to an embodiment of this application. Referring to FIG. 2a and FIG. 2b, in an embodiment of this application, a display device 101 includes: a bezel 150; a backlight module 140, disposed on the bezel 150; a display panel 110, disposed opposite to the backlight module 140, including a first substrate and a second substrate, and having an outer surface; a light shielding unit 125, disposed at a periphery of the outer surface of the display panel 110; and a middle frame unit 130, including a spacer 132 molded integrally, where the spacer 132 extends from a direction perpendicular to the periphery of the middle frame unit and is connected to the light shielding unit 125, where the light shielding unit 125 is made of a liquid adhesive material, and the light shielding unit 125 is located at the periphery of the display panel 110 and adhered to the display panel 110 and the spacer 132 of the middle frame unit 130.

In an embodiment, the liquid adhesive material is a dark-color light absorbing material.

In an embodiment, the dark-color light absorbing material can block or absorb reflected light.

In an embodiment, the liquid adhesive has adhesiveness, and is a material capable of adhering glass and metal and a metal compound.

In an embodiment, the liquid adhesive has high temperature stability, and can maintain a stable property under a condition of high temperature.

In an embodiment, the bezel 150 is made of aluminum or a composite material of aluminum.

In an embodiment, the first substrate 142 is disposed above the backlight module 140, and the first substrate 142 is a CF substrate.

In an embodiment, the second substrate 144 is disposed opposite to the first substrate 142, and the second substrate 144 is a TFT substrate.

In an embodiment, the display device further includes an LC layer 143, disposed between the first substrate 142 and the second substrate 144.

In an embodiment, manners of forming the first substrate 142 and the second substrate 144 include photoresist coating, exposure, development, and photomask processes.

Referring to FIG. 2a and FIG. 2b, in an embodiment of this application, an LCD device includes: a light source, configured to provide light to a backlight module 140, and a display device 101. The display device 101 includes: a bezel 150; the backlight module 140, disposed above the bezel 150; a display panel 110, disposed opposite to the backlight module 140, including a first substrate and a second substrate, and having an outer surface; a light shielding unit 125, disposed at a periphery of the outer surface of the display panel 110; and a middle frame unit 130, including a spacer 132 molded integrally, where the spacer 132 extends from a direction perpendicular to the periphery of the middle frame unit and is connected to the light shielding unit 125, where the light shielding unit 125 is made of a liquid adhesive material, and the light shielding unit 125 is located at the periphery of the display panel 110 and adhered to the display panel 110 and the spacer 132 of the middle frame unit 130.

In an embodiment, the liquid adhesive material is a dark-color light absorbing material.

In an embodiment, the dark-color light absorbing material can block or absorb reflected light.

In an embodiment, the liquid adhesive has adhesiveness, and is a material capable of adhering glass and metal and a metal compound.

In an embodiment, the liquid adhesive has high temperature stability, and can maintain a stable property under a condition of high temperature.

In an embodiment, the bezel 150 is made of aluminum or a composite material of aluminum.

In an embodiment, the first substrate 142 is disposed above the backlight module 140, and the first substrate 142 is a CF substrate.

In an embodiment, the second substrate 144 is disposed opposite to the first substrate 142, and the second substrate 144 is a TFT substrate.

In an embodiment, the display device further includes an LC layer 143, disposed between the first substrate 142 and the second substrate 144.

In an embodiment, manners of forming the first substrate 142 and the second substrate 144 include photoresist coating, exposure, development, and photomask processes.

In some embodiments, the color filter and the thin film transistor may be formed on a same substrate.

In some embodiments, the light source may be a light-emitting diode or a fluorescent lamp, or be disposed on a flexible substrate having a backlight module.

In some embodiments, the display device further includes a prism. The prism may be made of thermoplastic resin or a composite including thermoplastic resin. Thermoplastic resin is transparent in a range of visible light. Examples of thermoplastic resin may include acetal copolymer, acrylic resin, polycarbonate resin, polystyrol resin, polyester resin, ethenoid resin, polyphenylene oxide resin, polyolefin resin, cycloolefin resin, acrylonitrile-butadiene-styrene copolymer, polyacrylic ester, polyarylsulfone resin, polyethersulfone resins, phenylene sulfide resin, polyethylene naphthalate, polyethylene resin, and fluororesin.

According to this application, not only metal light reflection surrounding a TFT glass substrate can be absorbed, but also a problem of a poor visual sense due to metal light reflection can be alleviated. Because a liquid adhesive has advantages such as good adhesiveness, resistance to environmental changes, and controllability of the width of the liquid adhesive by adjusting an adhesive amount, and has good adhesiveness, light shielding performance, and weather resistance, a black liquid adhesive is used to replace a black double-sided adhesive tape used during assembly of a display panel. Because the liquid adhesive has better adhesiveness and resistance to environmental changes, and is not limited by a development towards a thin product and a narrow frame, there is no need to add an additional manufacturing process.

Phases such as “in some embodiments” and “in various embodiments” are repeatedly used. Usually, the phases do not refer to a same embodiment; but they may also refer to a same embodiment. Words such as “contain”, “have”, and “include” are synonyms, unless other meanings are indicated in the context.

Descriptions above are merely preferred embodiments of this application, and are not intended to limit this application. Although this application has been disclosed above through the preferred embodiments, the embodiments are not intended to limit this application. A person skilled in the art can make some equivalent variations, alterations or modifications to the above-disclosed technical content without departing from the scope of the technical solutions of this application to obtain equivalent embodiments. Any simple alteration, equivalent change or modification made to the above embodiments according to the technical essence of this application without departing from the content of the technical solutions of this application shall fall within the scope of the technical solutions of this application.

What is claimed is:

1. A display device, comprising:
a bezel;
a backlight module, disposed on the bezel;
a display panel, disposed opposite to the backlight module, comprising a first substrate and a second substrate, and having an outer surface;
a light shielding unit, disposed at a periphery of the outer surface of the display panel; and
a middle frame unit, comprising a spacer molded integrally, wherein the spacer extends from a direction perpendicular to the periphery of the middle frame unit and is connected to the light shielding unit;
wherein the light shielding unit is made of a liquid adhesive material, and the light shielding unit is located at the periphery of the display panel and adhered to the display panel and the spacer of the middle frame unit.

2. The display device according to claim 1, wherein the liquid adhesive material is a dark-color light absorbing material.

3. The display device according to claim 2, wherein the dark-color light absorbing material blocks reflected light.

4. The display device according to claim 2, wherein the dark-color light absorbing material absorbs reflected light.

5. The display device according to claim 1, wherein the liquid adhesive has adhesiveness, and is a material capable of adhering glass and metal and a metal compound.

6. The display device according to claim 1, wherein the liquid adhesive has high temperature stability, and maintains a stable property under a condition of high temperature.

7. The display device according to claim 1, wherein the bezel is made of aluminum or a composite material of aluminum.

8. The display device according to claim 1, wherein the first substrate is disposed above the backlight module, and the first substrate is a color filter (CF) substrate.

9. The display device according to claim 1, wherein the second substrate is disposed opposite to the first substrate, and the second substrate is a thin film transistor (TFT) substrate.

10. The display device according to claim 1, further comprising a liquid crystal (LC) layer, disposed between the first substrate and the second substrate.

11. A display device, comprising:
a bezel;
a backlight module, disposed on the bezel;
a display panel, disposed opposite to the backlight module, comprising a first substrate and a second substrate, and having an outer surface, wherein the first substrate comprises a color filter (CF), and the second substrate comprises a thin film transistor (TFT);
a light shielding unit, disposed at a periphery of the outer surface of the display panel; and
a middle frame unit, comprising a spacer molded integrally, wherein the spacer extends from a direction perpendicular to the periphery of the middle frame structure and is connected to the light shielding unit,
wherein
the light shielding unit is made of a liquid adhesive material, and the light shielding unit is located at the periphery of the display panel and adhered to the display panel and the spacer of the middle frame unit;
the liquid adhesive has adhesiveness, and is a material capable of adhering glass and metal and a metal compound; and has high temperature stability, and maintains a stable property under a condition of high temperature;
the liquid adhesive material is a dark-color light absorbing material, and the dark-color light absorbing material blocks or absorbs reflected light;
the bezel is made of aluminum or a composite material of aluminum; and
steps of forming the first substrate and the second substrate comprise photoresist coating, exposure, development, and photomask processes.
